(19) United States
(12) Patent Application Publication
(10) Pub. No.: US 2009/0064463 A1
(43) Pub. Date: Mar. 12, 2009

(54) Hinge for pivotally moving a laterally opening door

(75) Inventors: Günter Gomoll, Elchingen (DE); Bernd Heger, Haunsheim (DE); Wolfgang Kentner, Röfingen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH, München (DE)

(21) Appl. No.: 11/919,943

(22) PCT Filed: Apr. 7, 2006
(86) PCT No.: PCT/EP2006/061438

§ 371 Date: Nov. 5, 2007

(30) Foreign Application Priority Data
May 10, 2005 (DE) 10 2005 021 540.8

(51) Int. Cl. E05D 3/06

(52) U.S. Cl. 16/371; 16/221; 16/366; 312/236

(57) ABSTRACT

The invention relates to a hinge for hinged mounting of a laterally opening door of a cabinet, especially a hinge for a refrigerator. The hinge includes an articulated lever arrangement that is provided with a support element facing the door and a support element facing the cabinet. The support element facing the door is rotated by an opening angle from a closed position into an open position when the hinge is opened relative to the support element facing the cabinet. The support element facing the door is displaced by at least 65 mm, particularly at least 85 mm, preferably at least 95 mm, at an opening angle of ninety degrees.

The invention relates to a hinge, in particular a multiple-articulation hinge, for fastening a laterally opening door of a cabinet, in particular of a refrigerator, comprising an articulated lever arrangement which has a support element on the door side and a support element on the cabinet side, the support element on the door side being rotated by an opening angle from a closed position to an open position when the hinge is opened relative to the support element on the cabinet side. The invention also relates to a cabinet wall and to a refrigerator.

It is known for cabinets such as e.g. a refrigerator to be fitted with an articulated lever arrangement in order to enable a simple and reliable opening and an automatic closing of a door of the cabinet. In known uniaxial hinges the problem exists that, where, as is the case for example with refrigerator doors, door inserts extend far into the cabinet, the inner chamber of the cabinet is sometimes not fully accessible, even when the door is comparatively widely opened. Specifically in the case of refrigerators, this problem results in shelves in the door such as e.g. drinks shelves or shelves in the door for butter and eggs hindering direct access to the inner chamber of the refrigerator.

To solve this problem, the prior art provides hinges which use articulated arrangements in which a plurality of articulated levers form one or two four-bar mechanisms which, besides producing the rotational movement of the door, also produce a lateral movement. As a result of the lateral movement of the door, the inner chamber of the cabinet is largely unblocked, even in cases where door inserts extend comparatively far into the inner chamber of the cabinet. Due to the kinematics of these joints, the door is not only rotated during opening but also displaced laterally adjacent to the cabinet such that, compared with uniaxial hinges, greater clearance is provided at the same opening angle.

As has been shown, the known improved hinges nonetheless exhibit disadvantages where they are to be used with cabinet walls which have a projecting worktop or door knobs. In these cases, a lateral displacement of the door is possible only to a limited extent or is not possible at all due to the projection. As a result of an unfavorably positioned projection on the hinge side, the functionality of the known improved hinges can develop only inadequately and the inner chamber of the cabinet remains, in an undesired manner, partially blocked.

The object of the present invention is thus to provide a hinge for fastening a laterally opening door of a cabinet, in particular of a refrigerator, a cabinet wall with a hinge for fastening a laterally opening door and a refrigerator, with which easy access to an inner chamber of the cabinet is possible even when an opening of the door is hindered by projections located on the hinge side.

This object is achieved according to the invention in the hinge, in the cabinet wall and in the refrigerator as specified in the independent claims. Further advantageous embodiments, which can respectively be applied individually or randomly combined with one another, are the subject matter of the respective dependent claims.

In the inventive hinge for fastening a laterally opening door of a cabinet, in particular of a refrigerator, comprising an articulated lever arrangement which has a support element on the door side and on the cabinet side, the support element on the door side being rotated, when the hinge is opened, relative to the support element on the cabinet side from a closed position with an opening angle to an opened position, the support element on the door side is displaced, at an opening angle of 90°, by at least 65 mm, in particular at least 85 mm, preferably by at least 95 mm.

By virtue of the large displacement, the hinge assumes to a certain extent the function of a drawer and makes it possible for a door connected to the hinge to be pivoted around adjacent obstacles. As a consequence, the door can be opened further and the problem of an alteration of the interior of a cabinet is alleviated.

The opening angle relates to the closed position of the hinge, i.e. to the position in which the hinge is folded, which typically corresponds to the case when a cabinet door connected to the hinge is closed. The opening angle of 0° consequently corresponds to the closed position, even if the two support elements in the closed position occupy an angle not equal to zero, e.g. of 90°, relative to each other. The displacement is defined in relation to the change in distance between the support elements.

The hinge is advantageously suitable and determined for pivoting a door around a projection located on the hinge side. In a modification, the hinge can be used not only for fastening a laterally opening door but in principle also for doors which open upward or downward.

The support element on the door side is displaced advantageously at an opening angle of 90° by less than 180 mm, in particular less than 150 mm, preferably less than 120 mm. In the case of heavy refrigerator doors, a dimensioning of this kind aids the stability of the hinge.

A maximum opening angle (α) of the hinge (1) is at least 90°, in particular at least 100°, preferably at least 110°. Said maximum opening angle is advantageously less than 150°, in particular less than 130°, preferably less than 120°.

Here, too, the opening angle is the angle which the door occupies in an open position relative to its closed position. The angle is determined in the hinge plane, i.e. in the plane which stands vertically on the axes of articulation of the articulated lever arrangement. In the case of a laterally opening door, this plane is formed by the horizontal plane.

In a particular embodiment of the invention, a support element on the cabinet side, a first articulated lever on the cabinet side articulated on the support element on the cabinet side, a second articulated lever on the cabinet side articulated on the support element on the cabinet side, said second articulated lever being, in a hinging plane of the hinge, offset relative to the first articulated lever on the cabinet side, a support element on the door side, a first articulated lever on the door side articulated on the support element on the door side, and a second articulated lever on the door side articulated on the support element on the door side, said second articulated lever being in a hinging plane of the hinge offset relative to the first articulated lever on the door side, are provided, the first articulated lever on the cabinet side being articulated with both articulated levers on the door side while the second articulated lever on the cabinet side is articulated with only one of the two articulated levers on the door side, and the first articulated lever on the door side is articulated with both articulated levers on the cabinet side while the second articulated lever on the door side is articulated with only one of the two articulated levers on the cabinet side.

Such an arrangement of the support elements on the door side and on the cabinet side and of the first and second articulated levers on the door side and on the cabinet side forms a dual four-bar mechanism which, given appropriate dimensioning of the articulated levers, support elements and articulated points, is suitable for the inventive displacement, in particular with reference to the cabinet for a large forward movement extending into the free chamber. In particular, by this means, a hinge is created which, due to both a rotational and a translational movement during opening, allows or supports a pivoting of the door around an obstacle on the hinge side such as e.g. around a door handle or a projecting worktop.

In a particularly advantageous embodiment of the present invention the two first articulated levers are articulated such that a double-armed and a single-armed lever are formed in relation to their common first articulation point.

Double-armed means that longitudinally along the articulated lever in relation to the first articulation point an articulated lever arm on one side and on the other side, i.e. a two-sided articulated lever arm, is formed, while in a single-armed lever in relation to the common first articulation point an articulated lever arm is formed only one side, i.e. a one-sided articulated lever arm. In a double-armed articulated lever arm, the first articulation point is located between two further articulation points, while in a single-armed articulated lever arm, a further articulation point is located between the first articulation point and another articulation point.

In a particularly advantageous embodiment of the invention, at least one of the following features (β1) to (β10) is fulfilled:

(β1) The first and second articulated levers on the cabinet side are articulated on the support element (9) on the cabinet side offset at a first distance of at least 50 mm, in particular of at least 55 mm, preferably of at least 60 mm, and/or less than 85 mm, in particular less than 75 mm, preferably less than 65 mm.

(β2) The first and second articulated levers on the door side are arranged on the support element (10) on the door side offset at a second distance of least 35 mm, in particular of at least 40 mm, preferably of at least 45 mm, and/or less than 65 mm, in particular less than 58 mm, preferably less than 53 mm.

(β3) A third distance of the first articulation on the cabinet side of the first articulated lever on the cabinet side from the common first articulation point of the two first articulated levers is at least 80 mm, in particular at least 90 mm, preferably at least 100 mm, and/or not more than 125 mm, in particular not more than 115 mm, preferably not more than 105 mm.

(β4) A fourth distance of the first articulation on the cabinet side of the first articulated lever on the cabinet side from the common second articulation point of the first articulated lever on the cabinet side and the second articulated lever on the door side is at least 120 mm, in particular at least 140 mm, preferably at least 155 mm, and/or not more than 200 mm, in particular not more than 185 mm, preferably not more than 170 mm.

(β5) A fifth distance of the first articulation on the door side of the first articulated lever on the door side from the common first articulation point of the two first articulated levers is at least 85 mm, in particular at least 97 mm, preferably at least 105 mm, and/or not more than 135 mm, in particular not more than 123 mm, preferably not more than 115 mm

(β6) A sixth distance of the first articulation on the door side of the first articulated lever on the door side from the common third articulation point of the first articulated lever on the door side from the second articulated lever on the cabinet side is at least 50 mm, in particular at least 57 mm, preferably at least 62 mm, and/or not more than 82 mm, in particular not more than 75 mm, preferably not more than 70 mm.

(β7) A seventh distance of the common first articulation point of the two first articulated levers from the third articulation point of the first articulated lever on the door side and the second articulated lever on the cabinet side is at least 37 mm, in particular at least 42 mm, preferably at least 45 mm, and/or not more than 60 mm, in particular not more than 54 mm, preferably not more than 50 mm.

(β8) An eighth distance of the common first articulation point of the two first articulated levers from the second articulation point of the first articulated lever on the cabinet side and the second articulated lever on the door side is at least 48 mm, in particular at least 53 mm, preferably at least 58 mm, and/or not more than 75 mm, in particular not more than 69 mm, preferably not more than 63 mm.

(β9) A ninth distance of the second articulation on the door side of the second articulated lever on the door side from the common second articulation point of the second articulated lever on the door side and the first articulated lever on the cabinet side is at least 95 mm, in particular at least 105 mm, preferably at least 112 mm, and/or not more than 135 mm, in particular not more than 125 mm, preferably not more than 118 mm.

(β10) A tenth distance of the second articulation on the cabinet side of the second articulated lever on the cabinet side from the common third articulation point of the second articulated lever on the cabinet side and the first articulated lever on the door side is at least 68 mm, in particular at least 76 mm, preferably at least 82 mm, and/or not more than 105 mm, in particular not more than 95 mm, preferably not more than 88 mm.

By means of such dimensioning of the articulated levers, the articulation points and the support elements, advantageous properties of the hinge are created, which is advantageous in particular with respect to refrigerators in combination with kitchen cabinets.

The individual features (β1) to (β10) can respectively be single or combined arbitrarily with each other.

In particular, the ratios of the respective elements on the door side and on the cabinet side, as well as the distances of the first and second articulated levers from one other are advantageous for a stable and functional execution of the hinge. The respective ratios give the hinge the desired kinematics which is advantageous for displacing or lifting a door of a cabinet around or past a lateral obstacle.

The respective ratios to one another of the components used, i.e. the quotients of the lengths and distances of the respective support elements, articulated levers and articulation points, are thus particularly advantageous and particularly suitable as special embodiments of the invention.

In a further embodiment of the invention, the two first articulated levers are articulated such that in relation to their common first articulation point two double-armed levers are formed. In this case, the two first articulated levers respectively form in relation to their common first articulation point, which is fashioned as a crossing point, one articulated lever arm on one side and one articulated lever arm on the other side.

Advantageously, the hinge snaps shut when the hinge occupies an opening angle relative to the closed position that is less than 60°, in particular less than 45°, preferably less than 35°.

The automatic closing of the hinge effects a locking of the door, e.g. of a refrigerator door. The automatic snapping shut achieves a sealing effect which particularly in the case of refrigerator doors is a great advantage.

For the snapping-shut effect, spring elements such as e.g. gas-pressure springs can be used, by means of which between a closed position of the door, i.e. a closed position of the hinge, and an open position of the door, i.e. an open position of the hinge, a potential peak is passed through in which potential energy that can be used for opening or closing the hinge respectively is stored in the spring elements.

The hinge advantageously has a free run upward of an opening angle of at least 55°, in particular of at least 60°, preferably of at least 70°. Free run means that no forces that would cause a movement of the hinge in a closing or opening direction are exerted on the hinge or by the hinge.

In a special embodiment of the invention, the hinge may have a lockable stop for limiting the opening angle to less than 130°, in particular less than 115°, for example less than 100°, or even less than 90°. By means of the lockable stop, which can be formed for example by an attachable clip onto an articulation arm of the hinge, an excessive opening of the hinge, which could possibly result in the door striking adjacent cabinet or furniture elements, can be prevented.

The support element on the cabinet side can have a fastening surface on the cabinet side. The support element on the door side can have a fastening surface on the door side. When the hinge is in the closed position, these fastening surfaces can lie essentially parallel to one another.

Advantageously, the total height of the hinge in the folded-together position is less than 100 mm, in particular less than 90 mm, preferably less than 80 mm. Total heights of less than 60 mm are particularly preferred.

The cabinet wall according to the invention comprises a cabinet, in particular a refrigerator, and at least one door, which is articulated by means of the inventive hinge on the cabinet. By virtue of the special structure of the hinge, in particular the described dimensioning of the articulated-joint components, a high degree of flexibility in the design of cabinet walls is achieved in that lateral obstacles which would prevent the door from opening fully can, with the aid of the hinge according to the invention, be pivoted around in a simple manner.

In this case, a projection, in particular a worktop or a door handle, is disposed adjacent to the cabinet in particular on the hinge side, and the hinge is suitable and mounted so as to enlarge the opening angle of the door, said opening angle being limited by the projection, in particular a worktop or a door handle, by displacing the door around the projection during rotation.

The special design of the hinge and the appropriate mounting of the hinge on the cabinet produces a particularly large forward movement of the door into the free space such that a wide opening of the door can be achieved, thereby unblocking the interior of the cabinet, even when projections adjacent on the hinge side would prevent an opening of the door.

In the cabinet wall, the hinge advantageously serves to fasten the laterally opening door of the cabinet and comprises an articulated lever arrangement which is suitable for enlarging the opening angle of the door, said opening angle being limited by a projection, in particular a worktop or a door handle, disposed adjacent to the cabinet on the hinge side. The door has an inner edge on the hinge side which, when the door is opened, executes a rotational movement and a translatory movement, the inner edge of the door executing during opening a forward movement of at least 50 mm, in particular of at least 60 mm, preferably of at least 70 mm.

Advantageously, the inner edge of the door executes during opening a forward movement of less than 110 mm, in particular less than 95 mm, preferably less than 80 mm.

The forward movement enables a pivoting of the door around the projection, which causes interference with conventional articulated joints, such that despite the projection a wide opening of the door can be achieved. This enlarges the opening width of the door and facilitates access to the interior of the cabinet.

The inner edge is located on the inside of the door adjacent to the hinge and runs parallel to the axes of rotation of the hinge. In comparison to known solutions, even highly protrusive projections can be pivoted around by means of the forward movement which proceeds far into the inner chamber.

In one embodiment of the invention, the inner edge of the door executes during opening a lateral movement of at least 10 mm, in particular at least 15 mm, in particular at least 20 mm, preferably at least 25 mm and/or of less than 70 mm, in particular less than 50 mm, preferably less than 30 mm. The lateral movement assists unblocking of the cabinet interior in that projecting structures on the door facing the cabinet interior are moved laterally with the door, whereby improved access to the cabinet interior is obtained. In certain cases, lateral movements of over 100 mm may, for reasons of stability, be excessive.

It is generally advantageous if the displacement X of the forward movement of the inner edge is at least 1.5 times, in particular two times, advantageously three times, greater than the displacement Y of the lateral movement of the inner edge.

The refrigerator according to the invention, in particular a fridge and/or freezer, has a housing with a cooling chamber, a door with a door inside jutting into the cooling chamber when the door is in the closed position, and a hinge for executing a rotary sliding movement of the door, the cooling chamber having a cooling-chamber interior surface on the hinge side and the door being articulated on the housing such that, at an opening angle of the door of 90°, the inside of the door is essentially flush with the cooling-chamber interior surface.

Being flush in this context means that the inside of the door and the interior surface of the cooling chamber lie in one plane. Access to the cooling chamber is unblocked hereby.

In one embodiment, the door can execute a forward movement, in particular with a displacement of 20 mm to 100 mm, advantageously with a displacement of 60 mm to 80 mm, such that a projection which is adjacent on the hinge side, in particular a door handle or a projecting worktop, can be pivoted around. The projection juts in particular beyond a plane which is defined by the front of the refrigerator.

Advantageously, the door has a lateral edge on the door stop side and the lateral edge pivots, when the door is opened, around a projection disposed adjacent to the door on the hinge side, in particular a projection jutting out compared with a plane defined by the front of the refrigerator, and/or a furniture front panel, in particular a decorative panel.

The height of the projection can be 20 mm to 50 mm, the height of the decorative panel 5 mm to 15 mm.

The refrigerator according to the invention advantageously has the hinge according to the invention.

Further advantageous details and particular advantages will be explained in detail with the aid of the drawings below, which do not restrict the scope of the invention but are intended merely to illustrate it by way of example and in which:

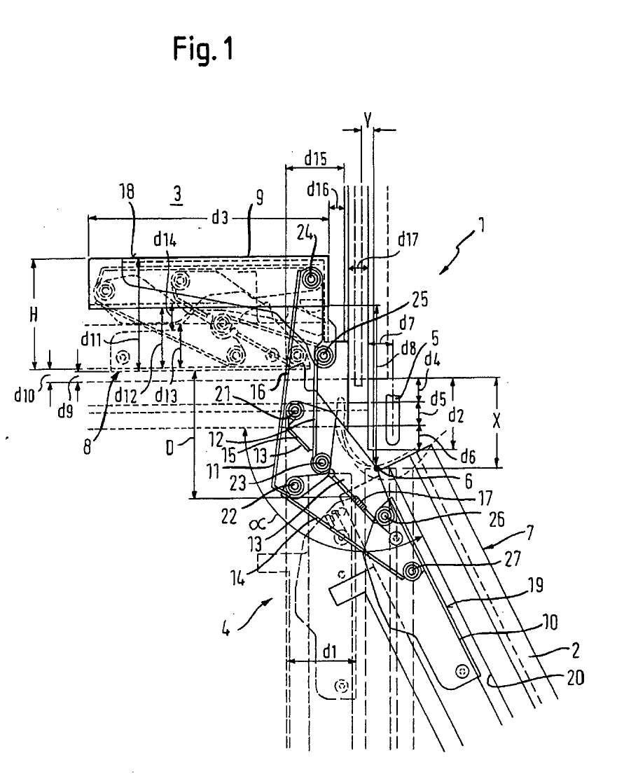

FIG. 1 shows schematically a sectional view of a hinge according to the invention in various opening positions, and

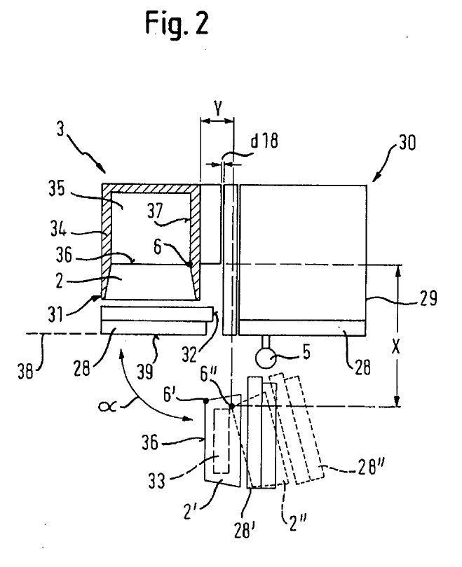

FIG. 2 shows a cabinet wall according to the invention with a hinge assembled according to the invention.

FIG. 1 shows a sectional view of a hinge 1 according to the invention, which hinge is fastened to a door 2 and to a cabinet 3, in various position 7,8, the hinge 1 being represented in a maximally open position 7 by solid lines and in a closed 8 and a half-open position by dashed lines.

The hinge 1 has an articulated lever arrangement 4, the kinematics of which allow an inner edge 6 of the door 2 to be displaced relative to an inner edge 6 in a forward movement with a displacement X such that a projection 5 hindering the opening of the door 2 on the hinge side can be pivoted around so as to unblock an interior (not shown) of the cabinet 3 despite projecting structures (not shown) on an inside 20 of the door 2. The door 2 and the hinge 1 are opened by an opening angle α of the opened door 2 and of the opened hinge 1 respectively relative to their closed position 8.

The articulated lever arrangement 4 has a support element 9 on the cabinet side, said element containing a first articulation 24 on the cabinet side and a second articulation 25 on the cabinet side on which a first articulated lever 11 on the cabinet side and a second articulated lever 12 on the cabinet side respectively are articulated.

Fastened to the door 2 is a support element 10 on the door side which contains a first articulation 26 on the door side and a second articulation 27 on the door side on which a first articulated lever 13 on the door side and a second articulated lever 14 on the door side are articulated.

The distance of the support element 9 on the cabinet side from the support element 10 on the door side changes when the hinge 1 is opened about an opening angle of 90° by D=105.8 mm, i.e. the support element 10 on the door side is displaced by D=105.8 mm.

The first articulated lever 11 on the cabinet side, the second articulated lever 12 on the cabinet side, the first articulated lever 13 on the door side and the second articulated lever 14 on the door side are connected to one another such that they form two four-bar mechanisms, the two first articulated levers 11, 13 being connected to one another at a first articulation point 21. At a second articulation point 22, the first articulated lever 11 on the cabinet side is articulated with the second articulated lever 14 on the door side. At a third articulation point 23, the first articulated lever 13 on the door side is connected to the second articulated lever 12 on the cabinet side.

By virtue of the type of connection of the door-side 13, 14 and cabinet-side 11, 12 articulated levers, the first articulated lever 13 on the door side constitutes a single-armed lever 15 and the first articulated lever 11 on the cabinet side a double-armed lever 16.

With the aid of a fastening surface 18 on the cabinet side, the hinge 1 is fastened with the cabinet-side support element 9 to the cabinet 3. With a fastening surface 19 on the door side, the door-side support element 10 is fastened to the door 2.

With the aid of a stop 17, which can be placed, e.g. clipped, on to an articulated lever 13, the maximum opening angle α of the hinge 1 or of the door 2 can be limited. An appropriate stop could likewise be realized in a screw (not shown).

Upon opening, the door 2 is displaced both forwardly and laterally and, in the process, is rotated. The door 2 or the hinge 1 consequently executes both a translatory movement and a rotational movement. Due to the large displacement X of the forward movement of 65 mm, a pivoting around the projection 5 hindering the opening of the door 2 is possible. The displacement Y of the lateral movement is less than the displacement X of the backward movement and totals 10 mm.

The following dimensions d1 to d17 are advantageous:

| | | | |
|---|---|---|---|
| d1 = 55.3 mm; | d2 = 57.3 mm; | d3 = 192 mm; | d4 = 19.1 mm; |
| d5 = 19.1 mm; | d6 = 19.1 mm; | d7 = 20 mm; | d8 = 127.6 mm; |
| d9 = 8 mm; | d10 = 11 mm; | d11 = 90 mm; | d12 = 44 mm; |
| d13 = 34.3 mm; | d14 = 12.1 mm; | d15 = 16 mm; | d16 = 46 mm; |
| d17 = 12 mm; | D = 105.8 mm. | | |

The following advantageous distances emerge therefrom:

First distance of the first articulated lever 11 on the cabinet side from the second articulated lever 12 on the cabinet side on the support element 9 on the cabinet side: 61.6 mm.

Second distance of the first articulated lever 13 on the door side from the second articulated lever on the door side on the support element 10 on the door side: 49 mm.

Third distance of the first articulation 24 on the cabinet side of the first articulated lever 11 on the cabinet side from the common first articulation point 21 of the two first articulated levers 11, 13: 102.7 mm.

Fourth distance of the first articulation 24 on the cabinet side of the first articulated lever 11 on the cabinet side from the common second articulation point 22 of the first articulated lever 11 on the cabinet side and the second articulated lever 14 on the door side: 162.7 mm.

Fifth distance of the first articulation 13 on the door side of the first articulated lever 13 from the common first articulation point 23 of the two first articulated levers 11, 13: 110.6 mm.

Sixth distance of the first articulation 26 on the door side of the first articulated lever 13 on the door side from the common third articulation point 23 of the first articulated lever on the door side from the second articulated lever on the cabinet side: 66.4 mm.

Seventh distance of the common first articulation point 21 of the two first articulated levers in the third articulation point of the first articulated lever 13 on the door side and the second articulated lever 12 on the cabinet side: 47.4 mm.

Eighth distance of the common first articulation point 21 of the two first articulated levers 11, 13 from the second articulation point 22 of the first articulated lever 11 on the cabinet side and the second articulated lever 14 on the door side: 60.0 mm.

Ninth distance of the second articulation 27 on the door side of the second articulated lever 14 from the common second articulation point 22 of the second articulated lever 14 on the door side and the first articulated lever 11 on the cabinet side: 115 mm.

Tenth distance of the second articulation 25 on the cabinet side of the second articulated lever 12 on the cabinet side from the common third articulation point 23 of the second articulated lever 12 on the cabinet side and the first articulated lever 13 on the door side: 85 mm.

FIG. 2 shows an excerpt of a sectional view of a cabinet wall 30 according to the invention with a hinge (not shown) mounted according to the invention on a cabinet 3 and with a line of kitchen units 29 which is arranged on the hinge side. The line of kitchen units 29 has a projection 5 which is formed by a door knob. This projection 5 is pivoted around by the door 2, 2′, 2″ which is faced with a furniture front panel 28. In this case, the reference characters with no inverted commas correspond to the closed position of the door 2, the reference characters with single inverted commas to a half-open position of the door 2′ with an opening angle α of 90° and the reference characters with double inverted commas to the maximally opened position of the door 2″. At maximum opening, the cabinet 3 is fully unblocked and access to a cabinet interior (not shown) is easily possible. The door 2, 2′, 2″ does not strike the projection 5 and can be opened without problem. The displacement X of the forward movement of the door 2, 2′, 2″ is 65 mm and the displacement Y of the lateral movement is 10 mm. The line of kitchen units is spaced at a distance d18=3 mm from the cabinet 3.

The displacement X of the forward movement is approximately three times as great as the displacement Y of the lateral movement.

The cabinet 3 is embodied as a refrigerator 31, i.e. as a freezer or as a fridge, with a housing 34 and a cooling chamber 35, the door 2 projecting in its closed position 8 with a door inside 36 into the cooling chamber 35 of the refrigerator 31. The door 2 has door storage shelves 33, such as e.g. drinks shelves, on the door inside 36, which are cooled in the cooling chamber 35. Due to the rotary sliding movement of the door 2, at an opening angle α of the door 2 of 90° the door inside 36 comes to lie flush with a cooling-chamber interior surface 37 on the hinge side of the cooling chamber 35, and a projection 5, which projects beyond a plane 38 defined by a front 39 of the refrigerator 31, is pivoted around by a lateral edge 32 on the door-stop side of the door 2 such that the door 2 can be opened widely despite this projection 5 and the cooling chamber 35 is fully unblocked. By means of the rotary sliding movements, projections of 50 mm and furniture front panels 28 with thicknesses of 20 mm can be pivoted around in a simple manner.

The invention relates to a hinge 1 for fastening a laterally opening door 2 of a cabinet 3, in particular of a refrigerator, comprising an articulated lever arrangement 4 which has a support element 10 on the door side and a support element 9 on the cabinet side, the support element 10 on the door side being rotated about an opening angle α from a closed position 8 to an open position 7 when the hinge 1 is opened relative to the support element 9 on the cabinet side, and the support element 9 on the door side being displaced at an opening angle (α) of 90° by at least 65 mm, in particular at least 85 mm, preferably by at least 95 mm. The invention also relates to a cabinet wall 30 and a refrigerator 31, it being possible for the door 2 to be opened widely in a simple manner in particular with the aid of the appropriately mounted hinge 1 according to the invention, even where there are projections 5 on the hinge side, such as e.g. a door handle located in the immediate vicinity of the hinge 1 or a projecting worktop, such that an access to the interior of the cabinet 3 is essentially fully unblocked.

### LIST OF REFERENCE CHARACTERS

1 hinge
2 door
3 cabinet
4 articulated lever arrangement
5 projection
6 inner edge
7 open position
8 closed position
9 support element on the cabinet side
10 support element on the door side
11 first articulated lever on the cabinet side
12 second articulated lever on the cabinet side
13 first articulated lever on the door side
14 second articulated lever on the door side
15 single-armed lever
16 double-armed lever
17 stop
18 fastening surface on the cabinet side
19 fastening surface on the door side
22 inside of the door 2
21 first articulation point between the first articulated lever (11) on the cabinet side and the first articulated lever (13) on the door side
22 second articulation point between the first articulated lever 11 on the cabinet side and the second articulated lever 14 on the door side
23 third articulation point between the first articulated lever 13 on the door side and the second articulated lever 12 on the cabinet side
24 first articulation on the cabinet side
25 second articulation on the cabinet side
26 first articulation on the door side
27 second articulation on the door side
28 furniture front panel
29 line of kitchen units
30 cabinet wall
31 refrigerator
32 lateral edge on the door stopping side
33 door storage shelves
34 housing
35 cooling chamber
36 inside of door
37 cooling-chamber interior surface on the hinge side
38 plane
39 front of refrigerator 31
X displacement of forward movement
Y displacement of lateral movement
H total height of hinge 1 in folded-closed position
αopening angle of open door 2 relative to its closed position 8
d1 to d18 distances

1-18. (canceled)

19. A hinge for fastening a laterally opening door of a compartment, the hinge comprising:
a.) an articulated lever arrangement;
b.) a door-side support element, the door-side support element interconnecting a door of a compartment with the articulated lever arrangement;
c.) a wall-side support element, the wall-side support element interconnecting a wall of the compartment with the articulated lever arrangement, and the door-side support element, the wall-side support element, and the articulated lever arrangement operating cooperatively with one another to support the door of the compartment in a movement of the door between an open position in which access can be had to the interior of the compartment and a closed position in which the door restricts access to the interior of the compartment, the door-side support element rotating, as the door moves from its closed position into its open position, through an angle that ultimately reaches an opening angle at the open position of the door; and
d.) means for guiding displacement of the door-side support element from an initial position thereof when the door is in its closed position to a displaced position when the door-side support element reaches an opening angle of a predetermined value, preferably an opening angle of ninety degrees (90°), with the displacement of the door-side support element from its initial position to its displaced position being a selected one of at least 65 mm, at least 85 mm, and at least 95 mm.

20. The hinge as claimed in claim 19, wherein, at an opening angle of the door-side support element of 90°, the door-side support element is displaced by a selected one of at less than 180 mm, less than 150 mm, and less than 120 mm.

21. The hinge as claimed in claim 19, wherein a maximum opening angle of the hinge is a selected one of at least 90°, at least 100°, at least 110° and less than 150°, less than 130°, and less than 120°.

22. The hinge as claimed in claim 19 and further comprising:
a support element on the cabinet wall side,
a first articulated lever on the cabinet wall side, articulated on the wall-side support element,
a second articulated lever on the cabinet wall side, articulated on the wall-side support element, the second articulated lever being offset in a hinge plane of the hinge in relation to the first articulated lever on the cabinet wall side,
a support element on the door side,
a first articulated lever on the door side, articulated on the door-side support element, and
a second articulated lever on the door side, articulated on the door-side support element, said second articulated lever being offset in a hinge plane of the hinge in relation to the first articulated lever on the door side, wherein the first articulated lever on the cabinet wall side is articulated with both articulated levers on the door side while the second articulated lever on the cabinet wall side is articulated only with one of the two articulated levers on the door side and the first articulated lever on the door side is articulated with both articulated levers on the cabinet wall side while the second articulated lever on the door side is articulated with only one of the two articulated levers on the cabinet wall side.

23. The hinge as claimed in claim 22, wherein the two first articulated levers are articulated such that, in relation to their common first articulation point, a double-armed and a single-armed lever are formed.

24. The hinge as claimed in claim 22, wherein:
(i) the first and second articulated levers on the cabinet side are articulated on the support element on the cabinet side offset at a first distance by at least 50 mm, in particular at least 55 mm, preferably at least 60 mm, and/or less than 85 mm, in particular less than 75 mm, preferably less than 65 mm;
(ii) the first and second articulated levers on the door side are arranged at a second distance on the support element on the door side offset by at least 35 mm, in particular by at least 40 mm, preferably by at least 45 mm, and/or less than 65 mm, in particular less than 58 mm, preferably less than 53 mm;
(iii) a third distance of the first articulation on the cabinet side of the first articulated lever on the cabinet side from the common first articulation point of the two first articulated levers is at least 80 mm, in particular at least 90 mm, preferably at least 100 mm, and/or not more than 125 mm, in particular not more than 115 mm, preferably not more than 105 mm;
(iv) a fourth distance of the first articulation on the cabinet side of the first articulated lever on the cabinet side from the common second articulation point of the first articulated lever on the cabinet side and the second articulated lever on the door side is at least 120 mm, in particular at least 140 mm, preferably at least 155 mm, and/or not more than 200 mm, in particular not more than 185 mm, preferably not more than 170 mm;
(v) a fifth distance of the first articulation on the door side of the first articulated lever on the cabinet side from the common first articulation point of the two first articulated levers is at least 85 mm, in particular at least 97 mm, preferably at least 105 mm, and/or not more than 135 mm, in particular not more than 123 mm, preferably not more than 115 mm;
(vi) a sixth distance of the first articulation on the door side of the first articulated lever on the door side from the common third articulation point of the first articulated lever on the door side from the second articulated lever on the cabinet side is at least 50 mm, in particular at least 57 mm, preferably at least 62 mm, and/or not more than 82 mm, in particular not more than 75 mm, preferably not more than 70 mm;
(vii) a seventh distance of the common first articulation point of the two first articulated levers from the third articulation point of the first articulated lever on the door side and the second articulated lever on the cabinet side is at least 37 mm, in particular at least 42 mm, preferably at least 45 mm, and/or not more than 60 mm, in particular not more than 54 mm, preferably not more than 50 mm;
(viii) an eighth distance of the common first articulation point of the two first articulated levers from the second articulation point of the first articulated lever on the cabinet side and the second articulated lever on the door side is at least 48 mm, in particular at least 53 mm, preferably at least 58 mm, and/or not more than 75 mm, in particular not more than 69 mm, preferably not more than 63 mm;
(ix) a ninth distance of the second articulation on the door side of the second articulated lever on the door side from the common second articulation point of the second articulated lever on the door side and the first articulated lever on the cabinet side is at least 95 mm, in particular at least 105 mm, preferably at least 112 mm, and/or not more than 135 mm, in particular not more than 125 mm, preferably not more than 118 mm;
(x) a tenth distance of the second articulation on the cabinet side of the second articulated lever on the cabinet side from the common third articulation point of the second articulated lever on the cabinet side and the first articulated lever on the door side is at least 68 mm, in particular at least 76 mm, preferably at least 82 mm, and/or not more than 105 mm, in particular not more than 95 mm, preferably not more than 88 mm.

25. The hinge as claimed in claim 22, wherein the two first articulated levers are articulated such that two double-armed levers are formed in relation to their common first articulation point.

26. The hinge as claimed in claim 19, wherein the hinge snaps shut when the door-side support element adopts an opening angle which is less than 60°, in particular less than 45°, preferably less than 35°.

27. The hinge as claimed in claim 19, wherein the hinge permits free running upward of an opening angle of at least 55°, in particular at least 60°, preferably at least 70°.

28. The hinge as claimed in claim 19 and further comprising a lockable stop for limiting the opening angle of the hinge to less than 130°, in particular less than 115°, in particular less than 100°, in particular less than 90°.

29. The hinge as claimed in claim 19, wherein the wall-side support element has a fastening surface on the cabinet side, the door-side support element has a fastening surface on the door side and the two fastening surfaces lie essentially parallel to one other when the hinge is in the closed position.

30. The hinge as claimed in claim 19, wherein the displacement of the door-side support element from its initial position to its displaced position is a selected one of less than 100 mm, in particular less than 90 mm, preferably less than 80 mm, particularly preferably less than 60 mm, when the hinge is in the closed position.

31. A compartment assembly comprising:
a.) means forming a compartment, in particular a refrigerator;
b.) a door; and
c.) a hinge for articulating movement of the door, the hinge having:
i.) an articulated lever arrangement;
ii.) a door-side support element, the door-side support element interconnecting a door of a compartment with the articulated lever arrangement;
iii.) a wall-side support element, the wall-side support element interconnecting a wall of the compartment with the articulated lever arrangement, and the door-side support element, the wall-side support element, and the articulated lever arrangement operating cooperatively with one another to support the door of the compartment in a movement of the door between an open position in which access can be had to the interior of the compartment and a closed position in which the door restricts access to the interior of the compartment, the door-side support element rotating, as the door moves from its closed position into its open position, through an angle that ultimately reaches an opening angle at the open position of the door; and
iv.) means for guiding displacement of the door-side support element from an initial position thereof when the door is in its closed position to a displaced position when the door-side support element reaches an opening angle of a predetermined value, preferably an opening angle of ninety degrees (90°), with the displacement of the door-side support element from its initial position to its displaced position being a selected one of at least 65 mm, at least 85 mm, and at least 95 mm.

32. The cabinet wall as claimed in claim 31, wherein a projection, in particular a worktop or a door handle, is disposed adjacent to the compartment forming means on the hinge side and the hinge is operable to enlarge the opening angle of the door with the opening angle being limited by the projection, in particular a worktop or a door handle, via the door displacing around the projection during rotation.

33. A housing comprising:
a.) a cooling compartment
b.) a door having a door inside that extends into the cooling compartment when the door is in a closed position; and
c.) a hinge for guiding a rotary sliding movement of the door, the door being mounted in an articulated manner on the housing and being movable between an open position in which access can be had to the interior of the cooling compartment and a closed position in which the door restricts access to the interior of the cooling compartment and, at an opening angle of the door of 90°, the inside of the door is essentially flush with an interior surface of the cooling compartment.

34. The refrigerator as claimed in claim 33, wherein the door is operable to execute a forward movement, in particular with a displacement of 20 mm to 100 mm, advantageously with a displacement of 60 mm to 80 mm, such that the door pivots around an adjacent projection on the hinge side, in particular, a door handle or a projecting worktop.

35. The refrigerator as claimed in claim 33, wherein the door has a lateral edge on the door stopping side and, when the door is opened, the lateral edge pivots around a projection disposed adjacent to the door on the hinge side, in particular a salient projection opposing a plane defined by the front of the refrigerator, and/or a furniture front panel, in particular, a decorative panel.

36. A refrigerator comprising:
a.) a cooling compartment;
b.) a door having a door inside surface that extends into the cooling compartment when the door is in a closed position; and
c.) a hinge for articulating movement of the door, the hinge having:
i.) an articulated lever arrangement;
ii.) a door-side support element, the door-side support element interconnecting the door with the articulated lever arrangement;
iii.) a wall-side support element, the wall-side support element interconnecting a wall of the cooling compartment with the articulated lever arrangement, and the door-side support element, the wall-side support element, and the articulated lever arrangement operating cooperatively with one another to support the door in a movement of the door between an open position in which access can be had to the interior of the compartment and a closed position in which the door restricts access to the interior of the cooling compartment, the door-side support element rotating, as the door moves from its closed position into its open position, through an angle that ultimately reaches an opening angle at the open position of the door; and
iv.) means for guiding displacement of the door-side support element from an initial position thereof when the door is in its closed position to a displaced position when the door-side support element reaches an opening angle of a predetermined value, preferably an opening angle of ninety degrees (90°), with the displacement of the door-side support element from its initial position to its displaced position being a selected one of at least 65 mm, at least 85 mm, and at least 95 mm, and, in the closed position of the door, the door inside surface is essentially flush with an interior surface of the cooling compartment.
